(19) United States
(12) Patent Application Publication
(10) Pub. No.: US 2018/0189090 A1
(43) Pub. Date: Jul. 5, 2018

(54) Exposing Hardware Work Queues as Virtual Devices in Virtual Machines

(71) Applicant: Microsoft Technology Licensing, LLC, Redmond, WA (US)

(72) Inventor: Hadden Mark Hoppert, Bellevue, WA (US)

(73) Assignee: Microsoft Technology Licensing, LLC, Redmond, WA (US)

(21) Appl. No.: 15/399,466

(22) Filed: Jan. 5, 2017

(51) Int. Cl. G06F 9/455

(52) U.S. Cl. CPC G06F 9/45558; G06F 2009/45579; G06F 2009/4557

(57) ABSTRACT

Techniques for exposing hardware work queues as virtual devices in virtual machines are described herein. In one or more implementations, a virtual machine device manager identifies control input/output (I/O) and data I/O hardware work queues of physical devices of a host device. The virtual machine device manager further selects a subset of identified data I/O hardware work queues to expose to the virtual machines as virtual devices. The virtual devices are generated by the virtual machine device manager to furnish functionality of the physical devices to the virtual machines. To do so, the virtual devices relay data between the virtual machines and the selected data I/O hardware work queues according to a mapping of input and output of the virtual devices to respective input and output of the selected data I/O hardware work queues. The virtual machine device manager also exposes the virtual devices to the virtual machines.

### BACKGROUND

In general, virtualization technologies have severed the one-to-one link between physical computing devices and operating systems by abstracting physical resources into virtualized resources. Virtualization allows multiple operating system instances or instances of an application to exist simultaneously on a same physical machine and in isolation from one another. Virtualization also enables multiple operating system instances to share a physical device's resources, such as to share storage devices, processing devices (e.g., graphics processing units (GPUs)), networking devices, and so forth. These advances have led to the centralization of many computing resources, enabling various computing tasks to be performed “over the cloud.”

By way of example, individuals associated with an enterprise may be given accounts that allow them to access an enterprise-configured desktop interface—the desktop interface may be configured to provide productivity tools selected by the enterprise, storage hosted by the enterprise, and so forth. The desktop interface associated with a given individual may also be accessible via multiple different computing devices, e.g., a desktop device at work, a laptop device at home, a tablet device while traveling, and so forth. Though accessible from these multiple different computing devices, the functionality provided by the desktop interface may be furnished largely using the processing and storage resources of the enterprise's servers, rather than resources of the computing devices the individuals interact with directly. Moreover, virtualization techniques enable the processing and storage resources of these same servers to be leveraged further to provide personal desktop interfaces simultaneously to multiple individuals of the enterprise. Advances continue to be made in virtualization technologies, e.g., improving the speed with which computing tasks can be completed using virtual machines, reducing the cost of implementing systems by employing virtual machines, and so forth. Nonetheless, some conventional techniques for implementing virtualization may be prohibitive to more widespread adoption. These techniques can be expensive and vulnerable to security breaches, for example. Consequently, virtualization may not be leveraged for many applications.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

Techniques for exposing hardware work queues as virtual devices in virtual machines are described herein. In one or more implementations, a virtual machine device manager identifies control input/output (I/O) and data I/O hardware work queues of physical devices with which a host device is configured. The virtual machine device manager further selects a subset of identified data I/O hardware work queues to expose to the virtual machines as virtual devices. The virtual devices are generated by the virtual machine device manager to furnish functionality of the physical devices to the virtual machines. To do so, the virtual devices relay data between the virtual machines and the selected data I/O hardware work queues according to a mapping of input and output of the virtual devices to respective input and output of the selected data I/O hardware work queues. The virtual machine device manager also exposes the virtual devices to the virtual machines, enabling the virtual machines to leverage the functionality of the physical devices.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 is a diagram depicting an example scenario in which a hardware work queue of a physical device is exposed to virtual machines as a virtual device in accordance with one or more implementations.

FIG. 3 is a diagram depicting an example configuration of a virtual device that emulates a physical device to a virtual machine in accordance with one or more implementations.

FIG. 4 is a flow diagram depicting an example procedure to expose hardware work queues as virtual devices in accordance with one or more implementations.

FIG. 5 is a flow diagram depicting an example procedure to furnish functionality of a physical device to a virtual machine via a virtual device in accordance with one or more implementations.

FIG. 6 illustrates an example system including various components of an example device that can be employed for one or more implementations of the techniques described herein.

### DETAILED DESCRIPTION

Overview

Advances continue to be made in virtualization technologies, e.g., improving the speed with which computing tasks can be completed using virtual machines, reducing the cost of implementing systems by employing virtual machines, and so forth. Nonetheless, some conventional techniques for implementing virtualization may be prohibitive to more widespread adoption. In general, virtualization can be implemented by host devices that furnish a host operating system. Under the host operating system, multiple guest operating systems can be instantiated. These guest operating systems may be referred to as “virtual machines,” emulating computing devices and providing the functionality of physical computers.

In connection with providing such functionality, virtual machines leverage the physical devices of a respective host device. Host devices can be configured with a variety of different physical devices for furnishing virtual machines with a wide range of functionality. Examples of such physical devices include storage devices, processing devices (e.g., graphics processing units (GPUs)), networking devices, and so on. However, conventional techniques for implementing virtualization may tie up a particular physical device while it is leveraged by a single virtual machine. To this extent, other virtual machines may not be able to leverage the functionality of that particular physical device at the same time. Instead, the other virtual machines may be forced to wait until the virtual machine currently using the physical device has finished. In many instances though, a single virtual machine leverages a mere portion of a physical device's capabilities. Thus, at a given time, at least some of the physical device's capabilities may simply be unused in connection with conventional techniques.

Exposing hardware work queues as virtual devices in virtual machines is described. In contrast to conventional techniques, the described techniques enable interactions between virtual machines and physical devices of the hosts by presenting the physical devices as virtual devices. These virtual devices limit the communications between the virtual machines and physical devices to input and output data. The virtual machines provide input data via the virtual devices to hardware work queues of the physical devices so that the physical devices can perform corresponding operations with the data. In turn, the physical devices provide output data (e.g., results of operations) to the virtual machines via the instantiated virtual devices. However, the communications between the virtual machines and the physical devices do not involve instructions configured for control registers of the physical devices, which control operations of the physical devices.

Consider an example in which a virtual machine leverages functionality of a host's networking device. Using conventional techniques, the virtual machine may provide data to a hardware work queue of the networking device that is to be communicated across a network. Using these conventional techniques, the virtual machines may also provide to a control-hardware connection of the networking device instructions for controlling operation of the networking device, such as commands that instruct the networking device to connect to a different routing device when a currently used routing device is unresponsive. In accordance with the described techniques, however, the virtual machine does not communicate such control commands to a networking device. Instead, implementation of the virtual devices limits the communications of the virtual machines to simply providing data that is to be communicated over the network. The virtual devices are also capable of providing output data to the virtual machines, such as data received over the network. Using the described techniques, responsibility for handling control-based instructions is offloaded from the virtual machines. Rather, control of the physical devices may be handled solely at the host-level, e.g., by a virtual machine device manager as described in more detail below.

Broadly speaking, the techniques described herein make functionality of physical devices available to virtual machines by exposing hardware work queues of the physical devices to the virtual machines as virtual devices. For instance, functionality of a networking device may be made available to a virtual machine as a virtual networking device. To the virtual machine, this virtual device may serve as the sole interface to the networking device—the virtual devices thus emulate physical devices for the virtual machines. Depending on capacity of a particular physical device, the described techniques also enable multiple hardware work queues of a single physical device to be exposed as multiple virtual devices simultaneously, e.g., when a networking device is capable of handling more network traffic than requested by a single virtual machine, one or more additional virtual devices representative of the networking device may be exposed.

In this way, the functionality of a physical device may be exposed to multiple different virtual machines simultaneously, and further, multiple virtual machines may leverage the functionality of a single physical device simultaneously. By enabling physical devices to perform operations for multiple virtual machines at a given time, the capabilities of a given physical device may be more fully leveraged than when the physical device is used to perform operations for a single virtual machine. This can result in a number of efficiencies for systems that employ virtualization according to the described techniques, such as reducing costs because fewer pieces of hardware may be needed to support a same number of virtual machines, reducing equipment footprint, reducing power consumption, and so on.

In the following discussion, an example environment is first described that may employ the techniques described herein. Example procedures and implementation details are then described which may be performed in the example environment as well as other environments. Consequently, performance of the example procedures and details is not limited to the example environment and the example environment is not limited to performance of the example procedures and details.

### Example Environment

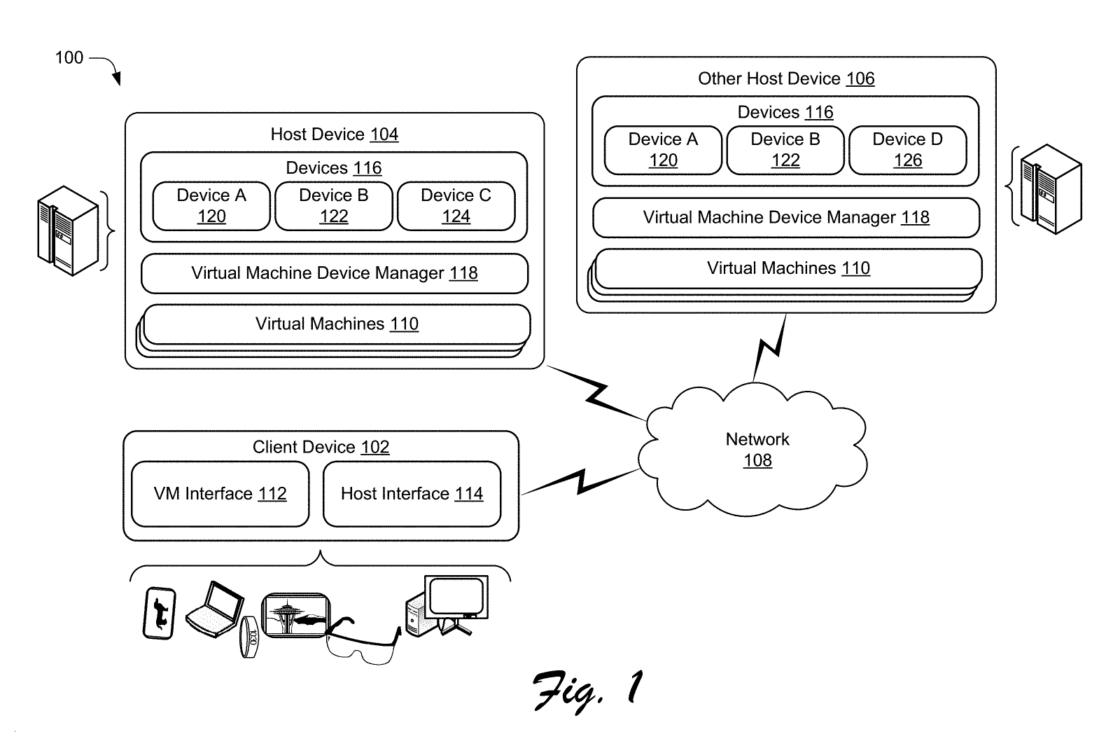

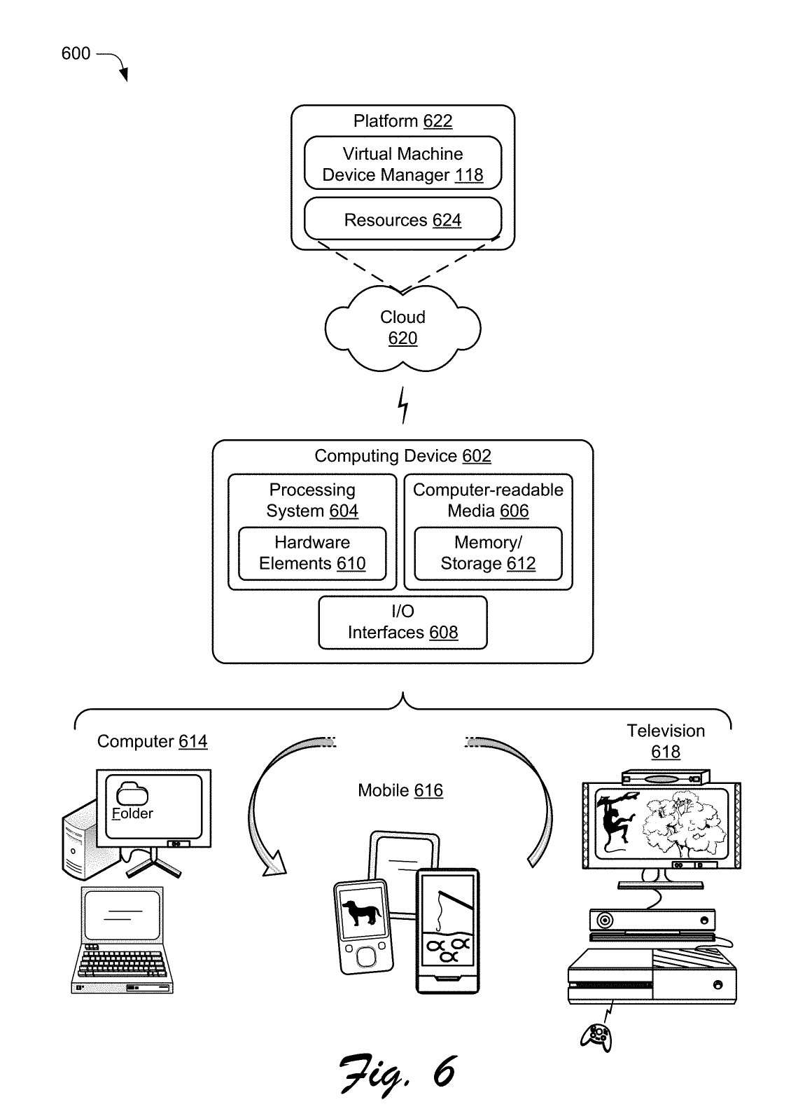

FIG. 1 illustrates an operating environment in accordance with one or more embodiments, generally at 100. The environment 100 includes a client device 102 which can be embodied as any suitable device, such as a desktop, a smartphone, a tablet computer, a portable computer (e.g., a laptop), a desktop computer, a set-top box, a game console, a wearable device, and so forth. Thus, the computing device may range from full resource devices with substantial memory and processor resources (e.g., personal computers, game consoles) to a low-resource device with limited memory and/or processing resources (e.g., traditional set-top boxes, hand-held game consoles). Additionally, although a single computing device is shown in some instances, the computing device may be representative of a plurality of different devices, such as multiple servers of a service provider utilized by a business to perform operations, provide a datacenter, and so on. Further examples of computing systems and devices suitable to implement techniques described herein are described below in relation to FIG. 6.

The environment 100 further includes host device 104 and other host device 106. The host device 104 and the other host device 106 may be implemented by one or more computing devices, such as one or more servers of a datacenter, and may also be representative of one or more entities. In accordance with one or more implementations, the host device 104 and the other host device 106 may represent functionality of a service provider to provide one or more services to the client device 102 over network 108. In general, service providers may make a variety of resources (e.g. content and services) available to clients of the network 108, which may include the hosts in some instances. Generally, resources made accessible by a service provider may include any suitable combination of services and/or content typically made available over a network by one or more providers. Some examples of services include, a virtual networking service (e.g., cloud computing), streaming content service, a search service, an email service, an instant messaging service, an online productivity suite, and an authentication service to control access of clients to the resources. Content may include various combinations of text, multi-media streams, documents, application files, photos, audio/video files animations, images, web pages, web applications, device applications, content for display by a browser or other client application, and the like.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The host device 104 and the other host device 106 are each illustrated as including virtual machines 110. The virtual machines 110 may be implemented as part of providing the above-mentioned services. Additionally, the virtual machines 110 may be implemented by virtual machine managers (not shown) of the host device 104 and the other host device 106. In general, a virtual machine manager may be capable of managing the creation (referred to herein as “instantiation”), operation, and termination of virtual machines 110. In at least some implementations, the virtual machine managers are configured as instances of hypervisor that run on a respective host device. Further, the virtual machines 110 represent instances of virtual machines hosted by respective host devices.

To enable interactions between the client device 102 and the virtual machines 110, the client device 102 includes a virtual machine interface 112 (VM interface 112). According to various implementations, the VM interface 112 represents functionality to expose one or more of the virtual machines 110 to the client device 102. By way of example, the VM interface 112 generates a graphical user interface (GUI) via which a user may interact with one of the virtual machines 110, such as to provide input to the virtual machine and consume output from the virtual machine.

The client device 102 is also depicted having host interface 114, which represents functionality to enable the client device 102 to interface with the host device 104 and/or the other host device 106 outside of the virtual machines 110. For instance, the host interface 114 supports functionality to request that a virtual machine manager instantiate one of the virtual machines 110 for the client device 102. The host interface 114 may also provide other functionality to the client device 102, such as enabling the status of different virtual machines to be determined and/or manipulated. The host interface 114 may provide a virtual machine interface, for instance, that indicates a status of different virtual machines to which the client device 102 is permitted visibility.

At some level, the functionality and/or services provided to the client device 102 via the virtual machines 110 are provided, at least in part, using actual physical devices of the host device 104 and the other host device 106. Devices 116 are representative of these actual physical devices, and enable the virtual machines 110 to emulate the functionality of actual computing devices. The devices 116 may include a variety of different physical devices capable of providing a wide range of functionality without departing from the spirit or scope of the techniques described herein. Some examples of the devices 116 include encoding devices, networking devices, compression engines, processing devices (such as graphics processing units (GPUs), data storage devices (such as hard drives), and so forth.

The host device 104 and the other host device 106 are also each illustrated with a virtual machine device manager 118. In accordance with the described techniques, the virtual machine device manager 118 exposes functionality of the devices 116 to the virtual machines 110. To do so, the virtual machine device manager 118 exposes hardware work queues of the devices 116 to the virtual machines 110 as virtual devices. In one or more implementations, the virtual machine device manager 118 is part of the above-discussed virtual machine manager. In any case, the virtual devices enable the virtual machines 110 to access functionality of the devices 116. When the devices 116 include a GPU for instance, the virtual devices allow the virtual machines 110 to request graphics processing from the GPU. In general, the virtual devices are indicative of availability of a given device to perform its corresponding functionality, e.g., for an encoding device a virtual encoding device indicates availability of the encoding device to encode data, for a networking device a virtual networking device indicates availability of the networking device to handle network traffic, and so on.

Broadly speaking, physical devices expose both control interfaces and hardware work queues—the control interfaces are exposed to enable overall control of the device and the hardware work queues are data interfaces exposed for queuing work corresponding to the functionality of the device. The virtual machine device manager 118 represents functionality to determine the control interfaces and data interfaces (e.g., hardware work queues) of the devices 116 and present a subset of the determined data interfaces to the virtual machines 110. In particular, the virtual machine device manager 118 configures virtual devices to represent the subset of determined data interfaces. The virtual machine device manager 118 can then present the virtual devices to the virtual machines 110. To the virtual machines 110, the virtual devices emulate the physical devices. Further, by presenting a subset of the hardware work queues of a particular physical device to individual virtual machines as a full virtual device, the functionality of the particular physical device can be shared among multiple virtual machines 110. To this extent, multiple virtual machines 110 may leverage the functionality of a single device 116 simultaneously.

In accordance with one or more implementations, the host device 104 and/or the other host device 106 may be configured with a virtual peripheral component interconnect (PCI) infrastructure. In such scenarios, the virtual machine device manager 118 can use the virtual PCI infrastructure to expose the hardware work queues to the virtual machines 110. In so doing, the virtual machine device manager 118 may expose the hardware work queues by presenting virtual machines in a way that mimics PCI Express (PCIe) devices. Consequently, the virtual machines 110 may treat the hardware work queues exposed as PCIe devices. As part of presenting the devices 116 to the virtual machines 110 as virtual devices, the virtual machine device manager 118 maps input/output of the virtual devices to the hardware work queues of the devices 116.

In the example environment 100, the devices 116 of the host device 104 are depicted including device A 120, device B 122, and device C 124, each of which may represent a single physical device with which the host device 104 is configured. The devices 116 of the other host device 106 are also illustrated having the device A 120 and the device B 122, which represents that the other host device 106 may be configured with at least some of the same physical devices as the host device. The devices 116 of the other host device 106 also include device D 126, but not the device C 124. This represents that the other host device 106 may be configured with at least some different physical devices than the host device 104.

Regardless of the particular physical devices with which the illustrated host devices are configured, the virtual machines 110 access functionality of the devices 116 via the virtual devices created by the virtual machine device manager 118. The virtual machine device manager 118 is capable of configuring these virtual devices and exposing them to virtual machines hosted by different host devices. By way of example, the host device 104's virtual machine device manager 118 can expose a virtual device for the device C 124 to the virtual machines 110 on the other host device 106. This enables the virtual machines 110 of the other host device 106 to access the functionality of the device C 124. In a similar manner, the other host device 106's virtual machine device manager 118 can expose a virtual device for the device D 126 to the virtual machines 110 on the host device 104. This enables the virtual machines 110 of the host device 104 to access the functionality of the device D 126. The host device 104's virtual machine device manager 118 can also expose virtual devices for the device A 120 and the device B 122 to the virtual machines of the other host device 106. In this way, the virtual machines 110 of the other host device 106 may leverage functionality of the device A 120 and the device B 122 of the host device 104, such as when the device A 120 and the device B 122 of the other host device 106 are operating at or near capacity, when an indicated wait time for performing corresponding functionality exceeds some threshold (or exceeds a wait time for the functionality of the device A 120 and the device B 122 of the host device 104), and so forth.

By accessing device functionality via virtual devices, rather than via actual hardware work queues, the virtual machines 110 can leverage the devices 116 of multiple host machines, including remote host machines. To this extent, the virtual machines 110 are not therefore tied to any specific physical device of a host. Since the virtual machines 110 are not tied to any specific physical device, the virtual machines 110 can migrate across different host devices. The virtual machines 110 may do so, for instance, based on the availability of device functionality. By way of example, a virtual machine may search virtual devices exposed by both the host device 104 and the other host device 106 to access functionality of the device A 120.

Having described an example operating environment, consider now example details and techniques associated with one or more implementations.

### Exposing Hardware Work Queues as Virtual Devices in Virtual Machines

To further illustrate, consider the discussion in this section of example scenarios, components, and procedures that may be utilized to expose hardware work queues as virtual devices in virtual machines. In general, functionality, features, and concepts described in relation to the examples above and below may be employed in the context of the example procedures described below. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

### Example Scenario

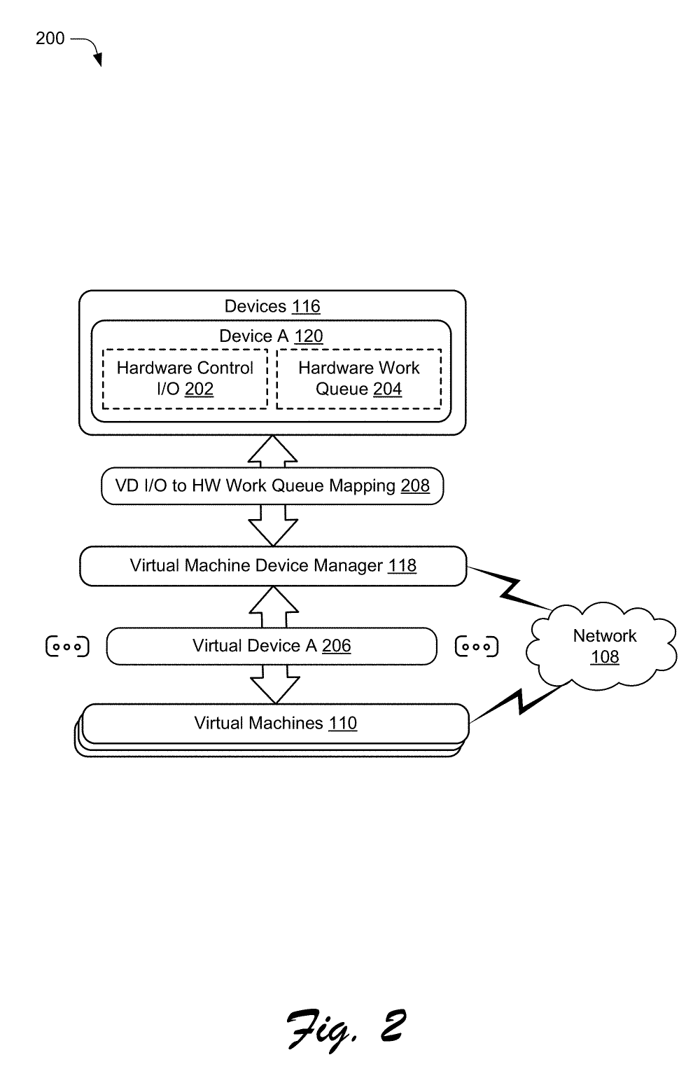

FIG. 2 depicts generally at 200 an example scenario in which a hardware work queue of a physical device is exposed to virtual machines as a virtual device in accordance with one or more implementations. The example scenario 200 includes, from FIG. 1, the virtual machines 110, the devices 116, and the virtual machine device manager 118. For purposes of clarity, the devices 116 in the example scenario 200 are depicted with solely the device A 120. It should be appreciated, however, that the described exposure of hardware work queues as virtual devices may be utilized for any of a variety of physical devices corresponding to the devices 116.

The device A 120 is depicted with hardware control input/output (I/O) 202 and hardware work queue 204. The hardware control I/O 202 represents a hardware interface that can be exposed to enable overall control of the device A 120. In conventional techniques, virtual machines may be configured to control at least some operations of the device A 120 using the hardware control I/O 202. In accordance with the techniques described herein though, the virtual machines interact with devices through virtual devices, and do not provide input to or receive output from the hardware control I/O 202. Instead, interactions to control the device A 120 through the hardware control I/O 202 may be handled at a host level, such as by the virtual machine device manager 118. The virtual machine device manager 118 may emulate the hardware control I/O 202 for a virtual device in software, for example. Thus, a virtual device may emulate the hardware control I/O 202 in lieu of allowing the virtual machines 110 to provide instructions via the hardware control I/O 202 for controlling operation of the device A 120. To this extent, virtual machines configured according to the described techniques are limited to providing input for and receiving output from hardware work queues via virtual devices.

The hardware work queue 204 represents a data interface capable of receiving data for queuing work to be performed by the device A 120. Consider an example in which the device A 120 is configured as a networking device. In this example, the hardware work queue 204 receives networking traffic data that the device A 120 can send out over the network 108. The hardware work queue 204 may also represent a data interface capable of outputting data that results from the functionality of the device A 120. Returning to the example in which the device A 120 is configured as the networking device, the hardware work queue 204 may also be capable of outputting networking traffic data received over the network 108. In at least some implementations, the device A 120 may be configured with more than one hardware work queue.

Regardless of a particular type of physical device, the virtual machine device manager 118 represents functionality to determine numbers and types of hardware control I/O and hardware work queues of a particular physical device. Using this information, the virtual machine device manager 118 can create virtual devices to emulate physical devices to the virtual machines 110. The example scenario 200 includes virtual device A 206, which is an emulation of the device A 120. The virtual machine device manager 118 is capable of creating the virtual device A 206 based on information describing the hardware control I/O 202 and the hardware work queue 204. The example scenario 200 depicts ellipses next to the virtual device A 206. These represent that the virtual machine device manager 118 is also capable of creating multiple virtual devices for the device A 120 (e.g., one or more devices in addition to the virtual device A 206), such as when the device A 120 is configured with multiple hardware work queues, has capacity to accept more work data to perform its corresponding functionality, and so forth. The virtual machine device manager 118 can add and subtract queues to the device A 120 by adjusting a number of the virtual devices in real-time, for instance.

The example scenario 200 also includes the network 108. In one or more implementations, the virtual machine device manager 118 is not only capable of presenting the virtual device A 206 to the virtual machines 110 of a host having the particular physical device A 120, but is also capable of presenting the virtual device A 206 to virtual machines of other hosts, such as host devices connected over the network 108. Additionally, the virtual machine device manager 118 may use a virtual peripheral component interconnect (PCI) infrastructure for presenting the virtual devices to the virtual machines 110. In this way, the virtual devices can be configured to look like PCIe devices to the virtual machines 110. Accordingly, the virtual machine device manager 118 may support a driver infrastructure to emulate the PCIe devices in the virtual machines 110.

In accordance with the described techniques, the virtual machine device manager 118 is configured to expose the hardware work queue 204 of the device A 120 to the virtual machines 110 as the virtual device A 206. To do so, the virtual machine device manager 118 may generate a virtual device input/output to hardware work queue mapping 208 (VD I/O to HW work queue mapping 208), which represents a mapping of inputs and outputs of the virtual device A 206 to the hardware work queue 204. The virtual machine device manager 118 may generate the VD I/O to HW work queue mapping 208 based on determining the hardware work queue 204 of the device A 120 as described above.

In this context, the virtual device A 206 receives input data from the virtual machines 110, which is input to the hardware work queue 204. Further, after the device A 120 performs its corresponding functionality with the input data, the virtual device A 206 obtains data output by the device A 120 and provides the output data to the virtual machines 110. This is carried out, in part, by providing the input data received from the virtual machines 110 as input to the hardware work queue 204 according to the VD I/O to HW work queue mapping 208. In addition, the output data obtained from the device A 120 is output to the virtual machines 110 via the virtual device A 206 according to the VD I/O to HW work queue mapping 208.

### Example Virtual Device

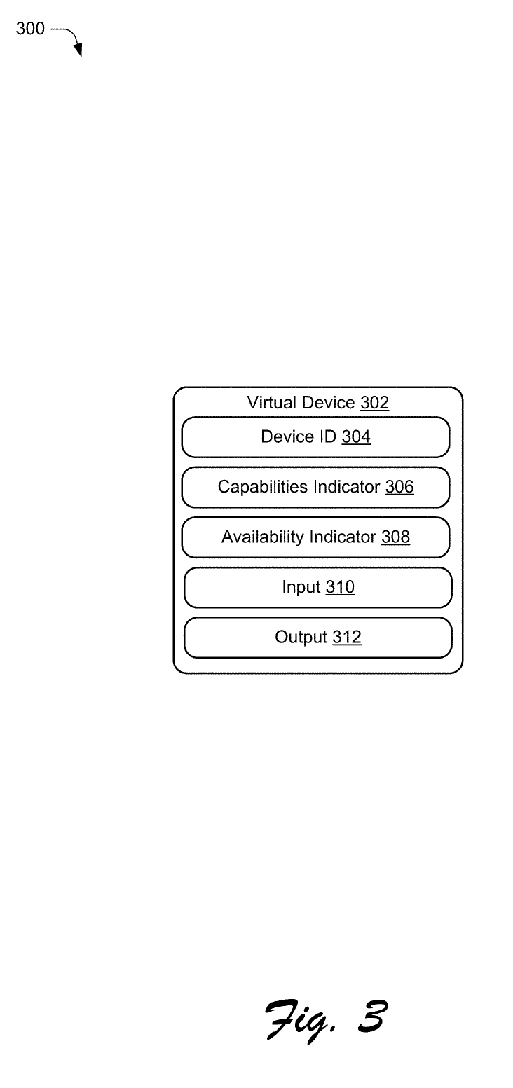

FIG. 3 depicts an example generally at 300 of a virtual device configuration that emulates a physical device to a virtual machine. The illustrated example 300 includes virtual device 302, which may be representative of any of a variety of physical devices, such as an encoding device, a networking device, a compression device, a processing device (e.g., a GPU), a hard drive, and so on.

The virtual device 302 of the illustrated example 300 includes device ID 304, capabilities indicator 306, availability indictor 308, input 310, and output 312. Virtual devices may be configured with different components without departing from the spirit or scope of the techniques described herein. In accordance with the described techniques, the virtual device 302 may be created with the described components by the virtual machine device manager 118 to expose at least one hardware work queue of a physical device.

The device ID 304 is configured to represent an identifier of an actual physical device represented by the virtual device 302. The device ID 304 may indicate a class of physical devices (e.g., a networking device), a particular device model, a unique identifier supplied for a physical device at manufacture, and so forth. The capabilities indicator 306 is configured to indicate capabilities of the physical device represented by the virtual device 302. By way of example, the capabilities indicator 306 may indicate that the virtual device 302 provides functionality to encode data, handle networking traffic, compress data, perform processing on data, store data, and so on. In particular, the capabilities indicator 306 may indicate the capabilities of the respective physical device. The availability indicator 308 is configured to indicate to the virtual machines 110 an availability to handle workloads. By way of example, the availability indicator 308 may be a binary indicator capable of simply indicating that the physical device represented by the virtual device 302 is or is not capable of handling a workload. Alternately, the availability indicator 308 may indicate a quantity of work the physical device represented by the virtual device 302 is capable of handling, e.g. for a networking device the availability indicator 308 may indicate available bandwidth. Further still, the availability indicator 308 may indicate an amount of time until the physical device represented by the virtual device 302 is capable of handling a workload.

The input 310 and the output 312 are representative of components capable of receiving input from the virtual machines 110 and providing output to the virtual machines 110, respectively. The input 310 receives data from the virtual machines 110. The received data is then input to a hardware work queue of a physical device to carry out its corresponding functionality. Output data from the physical device may be obtained by the virtual device 302. The output 312 provides this output data to the virtual machines 110. Consider an example in which the virtual device 302 represents a networking device, in accordance with one or more implementations. In this example, the input 310 may represent functionality of the virtual device 302 to receive requests from a virtual machine to send data over the network 108. Similarly, the output 312 may represent functionality of the virtual device 302 to output network traffic received for the virtual machine over the network 108.

Although the virtual device 302 of this example includes the depicted components, virtual devices configured in accordance with the described techniques may include different components without departing from the spirit or scope of the techniques herein. By way of example, the virtual device 302 may be configured according to a virtual PCI infrastructure to include different components than those depicted. Additional examples and details are discussed in relation to the following example procedures.

### Example Procedures

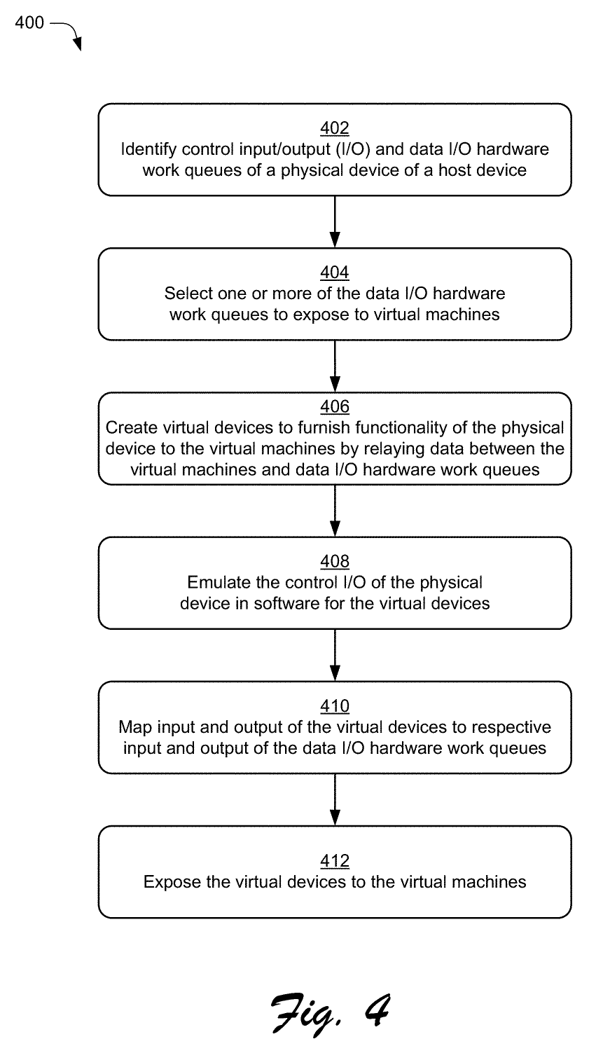

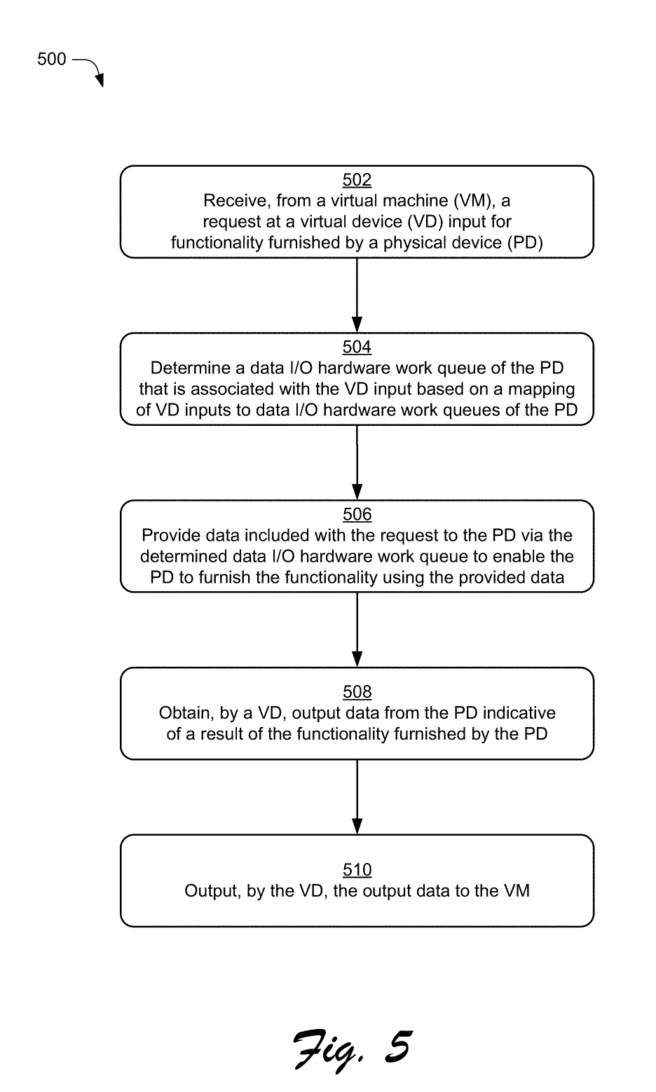

Further aspects of exposing hardware work queues as virtual devices in virtual machines are discussed in relation to example procedures of FIGS. 4 and 5. The procedures are represented as sets of blocks that specify operations performed by one or more devices and are not necessarily limited to the orders shown for performing the operations by the respective blocks. Aspects of the procedures may be implemented in hardware, firmware, or software, or a combination thereof. Some aspects of the procedures may be implemented via one or more host devices, such as via a host device 104 and/or other host device 106 that maintain and provide access to a virtual machine device manager 118 or otherwise. Aspects of the procedures may also be performed by a suitably configured device, such as the example client device 102 of FIG. 1 that includes or makes use of a VM interface 112 and host interface 114.

FIG. 4 depicts an example procedure 400 for exposing hardware work queues as virtual devices in accordance with one or more implementations.

At 402, control input/output (I/O) and data I/O hardware work queues are identified for a physical device incorporated into a host device. By way of example, the virtual machine device manager 118 identifies that device A 120 includes the hardware control I/O 202 and the hardware work queue 204. The virtual machine device manager 118 may do so based on information describing the device A 120, which may be obtained directly from the device A 120, by analyzing the control and data interfaces of the device A 120, obtained from a respective host device, obtained from a device identification service using a device identifier, and so forth.

At 404, one or more of the identified data I/O hardware work queues are selected to be exposed to virtual machines. By way of example, the virtual machine device manager 118 selects to expose the hardware work queue 204 to the virtual machines 110. At 406, virtual devices are created to furnish functionality of the physical device to the virtual machines. In accordance with the principles discussed herein, the virtual devices furnish the functionality of the physical device, at least in part, by relaying data between the virtual machines and the data I/O hardware work queues of the physical device. By way of example, the virtual machine device manager 118 creates the virtual device A 206 to furnish functionality of the device A 120 to the virtual machines 110. In some scenarios, the virtual machine device manager 118 also creates one or more additional virtual devices, such as when the capabilities of the device A 120 allow it to furnish functionality to multiple virtual machines 110 simultaneously. The creation of multiple virtual devices for the device A 120 is represented by the ellipses depicted next to the virtual device A 206 in FIG. 2.

At 408, the control I/O of the physical device is emulated in the virtual devices. By way of example, the virtual machine device manager 118 configures the virtual device A 206 to emulate the hardware control I/O 202 of the device A 120. As a result, the interactions between the virtual machines 110 and the virtual device A 206 can exclude communication of control instructions directed to the hardware control I/O 202. Broadly speaking, this offloads the responsibility of controlling the operations of the device A 120 from the virtual machines 110. In a scenario in which the device A 120 is configured as a networking device, for instance, the responsibility of instructing the networking device to reset a faulty connection to a routing device is offloaded from the virtual machines 110. Instead, the emulation of the control interfaces limits the information the virtual machines 110 provide to data that the physical devices handle through data hardware work queues, e.g., networking traffic in the networking device example.

At 410, input and output of the virtual devices is mapped to respective input and output of the data I/O hardware work queues. By way of example, the input 310 and the output 312 of the virtual device 302 are mapped to respective input and output of the data I/O hardware work queues of the corresponding physical device. This is used to form a data structure capable of being stored and updated to indicate the mapping, such as the virtual device I/O to hardware work queue mapping 208 (VD I/O to HW work queue mapping 208). The VD I/O to HW work queue mapping 208 is referenced to relay data input to the input 310 by the virtual machines 110 to a data I/O hardware work queue, such as the hardware work queue 204 of the device A. Similarly, the VD I/O to HW work queue mapping 208 is referenced to relay data output by the physical device as a result of furnishing its functionality to the output 312 of the virtual device 302.

At 412, the virtual devices are exposed to the virtual machines. By way of example, the virtual machine device manager 118 exposes the virtual device A 206 (and any additional virtual devices created) to the virtual machines 110. In one or more scenarios, the virtual machine device manager 118 exposes virtual devices to the virtual machines 110 on a one-to-one basis (e.g., one virtual device is exposed to one virtual machine). Alternately, the virtual machine device manager 118 exposes virtual devices to the virtual machines 110 on a many-to-each basis (e.g., multiple virtual devices are exposed to each virtual machine). The virtual machine device manager 118 may also expose multiple virtual devices corresponding to a single physical device at once, or may expose a single virtual device corresponding to the single physical device—the number of virtual machines exposed being based on the capacity of the physical device. In one or more implementations, the virtual machine device manager 118 exposes virtual devices to virtual machines hosted on multiple different host machines, such as host machines communicatively coupled one to another, e.g., via the network 108.

FIG. 5 depicts an example procedure 500 in which a virtual machine utilizes a virtual device to leverage functionality furnished by a corresponding physical device in accordance with one or more implementations.

At 502, a request is received at a virtual-device input from a virtual machine. In accordance with the principles discussed herein, the request requests functionality furnished by a physical device represented by the virtual device. By way of example, at the input 310 a request is received from one of the virtual machines 110. The received request requests functionality that is furnished by a physical device corresponding to the virtual device 302. In the context of FIG. 2, a request is received at an input of the virtual device A 206 from one of the virtual machines 110, and requests functionality that is furnished by the device A 120.

At 504, a data I/O hardware work queue of the physical device that is associated with the virtual-device input is determined. In accordance with the principles discussed herein, the data I/O hardware work queue is determined based on a mapping of virtual-device input and output to respective input and output of the physical device's data I/O hardware work queues. By way of example, the virtual machine device manager 118 determines a data I/O hardware work queue of a physical device that is associated with the input 310 of the virtual device 302. In the context of FIG. 2, the virtual machine device manager 118 makes this determination by referencing the VD I/O to HW work queue mapping 208. Further in the context of FIG. 2, the virtual machine device manager 118 determines the hardware work queue 204 as being associated with an input of the virtual device A 206.

At 506, data included with the request is provided to the physical device via the determined data I/O hardware work queue. In accordance with the principles discussed herein, this enables the physical device to furnish its functionality using the provided data. By way of example, data corresponding to the request received at 502 is provided to the device A 120 via the hardware work queue 204.

At 508, output data is obtained by the virtual device from the physical device. In accordance with the principles discussed herein, the output data is indicative of a result of the functionality furnished by the physical device. By way of example, the virtual device A 206 obtains data from the device A 120. Further, the obtained data is indicative of a result of the functionality furnished by the device A 120. When the device A 120 corresponds to a GPU, for example, the output data may correspond to a rendered scene configured for display.

At 510, the output data is output from the virtual device to the virtual machine. By way of example, the output data obtained at 508 is output by the virtual device A 206 to one of the virtual machines 110. In the context of FIG. 3, the output data obtained at 508 is output by the output 312 of the virtual device 302 to one of the virtual machines 110.

Having described example procedures and details in accordance with one or more implementations, consider now a discussion of example systems and devices that can be utilized to implement the various techniques described herein.

### Example System and Device

FIG. 6 illustrates an example system 600 that includes an example computing device 602 that is representative of one or more computing systems and/or devices that may implement the various techniques described herein. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, computer-readable media may include “computer-readable storage media” and “communication media.”

“Computer-readable storage media” refers to media and/or devices that enable storage of information in contrast to mere signal transmission, carrier waves, or signals per se. Computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 602, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, communication media include wired media such as a wired network or direct-wired connection, and wireless media such as acoustic, RF, infrared, and other wireless media.

As previously described, hardware elements 610 and computer-readable media 606 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the VM interface 112, the host interface 114, the virtual machine manager module 118, and other program modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of modules as a module that is executable by the computing device 602 as software may be achieved at least partially in hardware, e.g., through use of computer-readable storage media and/or hardware elements 610 of the processing system. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, and television 618 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. For example, the functionality of the virtual machine device manager 118 and other modules may also be implemented all or in part through use of a distributed system, such as over a “cloud” 620 via a platform 622 as described below. The virtual machine device manager 118 may also be implemented by a host device of the platform 622, such as by one or more servers of a datacenter. The virtual machine device manager 118 may also be implemented by an individual computing device 602 or host as described herein.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services provided over the Internet and/or through a subscriber network, such as a cellular or Wi-Fi network. The service may include virtualization services implemented via a suitably configured virtual machine manager module, such as one that includes the virtual machine device manager 118.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### Example Implementations

Example implementations of techniques described herein include, but are not limited to, one or any combinations of the following examples:

### Example 1

A method implemented by a computing device, the method comprising: identifying data input/output (I/O) hardware work queues of a physical device that is included as part of a host device hosting virtual machines; selecting one or more of the identified data I/O hardware work queues to expose to the virtual machines; and generating virtual devices to furnish functionality of the physical device to the virtual machines by relaying data between the virtual machines and the selected data I/O hardware work queues.

### Example 2

A method as described in example 1, further comprising mapping input and output of the virtual devices to respective input and output of the selected data I/O hardware work queues.

### Example 3

A method as described in example 2, wherein the virtual devices relay the data between the virtual machines and the selected data I/O hardware work queues according to the mapping.

### Example 4

A method as described in example 1, further comprising identifying control I/O of the physical device, wherein generating the virtual devices includes configuring the virtual devices to emulate the identified control I/O of the physical device in lieu of allowing the virtual machines to provide instructions via the identified control I/O for controlling operation of the physical device.

### Example 5

A method as described in example 1, further comprising exposing the virtual devices to the virtual machines, the exposed virtual devices relaying the data between the virtual machines and the selected data I/O hardware work queues to furnish the functionality of the physical device to the virtual machines.

### Example 6

A method as described in example 5, wherein the exposed virtual devices are exposed to at least one of the virtual machines hosted on the host device or the virtual machines hosted on a different host device.

### Example 7

A method as described in example 5, wherein the exposed virtual devices are configured to furnish the functionality of the physical device to at least two of the virtual machines simultaneously.

### Example 8

A method as described in example 1, wherein the physical device comprises at least one of: an encoding device; a networking device; a compression engine; a processing device; or a data storage device.

### Example 9

A method as described in example 8, wherein the physical device comprises a processing device configured as a graphics processing unit (GPU).

### Example 10

A method as described in example 1, further comprising: identifying data I/O hardware work queues of at least one additional physical device included as part of the host device; selecting one or more of the identified data I/O hardware work queues of the at least one additional physical device to expose to the virtual machines; generating additional virtual devices to furnish functionality of the at least one additional physical device to the virtual machines by relaying data between the virtual machines and the selected data I/O hardware work queues of the at least one additional physical device; and exposing the additional virtual devices to the virtual machines.

### Example 11

A host device comprising: a plurality of physical devices having data input/output (I/O) hardware work queues to receive data a respective physical device utilizes to furnish corresponding functionality; a processor; and computer-readable media having instructions stored thereon that are executable by the processor to implement a virtual machine device manager to perform operations for virtualizing the plurality of physical devices, the operations comprising: identifying the data I/O hardware work queues of the plurality of physical devices; and generating virtual devices representative of the plurality of physical devices, the generated virtual devices configured to furnish functionality of the plurality of physical devices to virtual machines by relaying the data utilized by the plurality of physical devices between the virtual machines and the identified data I/O hardware work queues of the plurality of physical devices.

### Example 12

A host device as described in example 11, wherein the plurality of physical devices comprises one or more of: an encoding device; a networking device; a compression engine; a processing device; or a data storage device.

### Example 13

A host device as described in example 11, wherein the operations further comprise exposing the generated virtual devices to at least one of virtual machines hosted by the host device or different virtual machines hosted by at least one different host device.

### Example 14

A host device as described in example 11, wherein the operations further comprise mapping input and output of the generated virtual devices to respective input and output of the identified data I/O hardware work queues and relaying the data utilized by the plurality of physical devices according to the mapping.

### Example 15

A host device as described in example 11, wherein a number of the virtual devices generated for a particular physical device is based on a quantity of functionality the particular physical device is configured to furnish.

### Example 16

A host device as described in example 15, wherein the generating includes generating at least two of the virtual devices to represent the particular physical device.

### Example 17

A host device as described in example 16, wherein the operations further comprise furnishing the functionality of the particular physical device to at least two of the virtual machines simultaneously via the at least two virtual devices.

### Example 18

A method implemented by a host device, the method comprising: receiving, from a virtual machine and at an input of a virtual device, a request requesting functionality furnished by a physical device corresponding to the virtual device; determining a data input/output (I/O) hardware work queue of the physical device that is associated with the input of the virtual device based on a mapping of virtual-device inputs to data I/O hardware work queues of the physical device; providing data included with the request to the physical device via the determined data I/O hardware work queue to enable the physical device to furnish the requested functionality with the provided data; obtaining, by the virtual device, output data from the physical device that is indicative of a result of the functionality furnished by the physical device; and outputting, by the virtual device, the output data to the virtual machine.

### Example 19

A method as described in example 18, wherein the data included with the request excludes instructions for controlling operations of the physical device via control I/O of the physical device.

### Example 20

A method as described in example 18, wherein at least some of the output data is displayable by a client device exposed to the virtual machine.

### CONCLUSION

Although techniques have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter

What is claimed is:

1. A method implemented by a computing device, the method comprising:
identifying data input/output (I/O) hardware work queues of a physical device that is included as part of a host device hosting virtual machines;
selecting one or more of the identified data I/O hardware work queues to expose to the virtual machines; and
generating virtual devices to furnish functionality of the physical device to the virtual machines by relaying data between the virtual machines and the selected data I/O hardware work queues.

2. The method of claim 1, further comprising mapping input and output of the virtual devices to respective input and output of the selected data I/O hardware work queues.

3. The method of claim 2, wherein the virtual devices relay the data between the virtual machines and the selected data I/O hardware work queues according to the mapping.

4. The method of claim 1, further comprising identifying control I/O of the physical device, wherein generating the virtual devices includes configuring the virtual devices to emulate the identified control I/O of the physical device in lieu of allowing the virtual machines to provide instructions via the identified control I/O for controlling operation of the physical device.

5. The method of claim 1, further comprising exposing the virtual devices to the virtual machines, the exposed virtual devices relaying the data between the virtual machines and the selected data I/O hardware work queues to furnish the functionality of the physical device to the virtual machines.

6. The method of claim 5, wherein the exposed virtual devices are exposed to at least one of the virtual machines hosted on the host device or the virtual machines hosted on a different host device.

7. The method of claim 5, wherein the exposed virtual devices are configured to furnish the functionality of the physical device to at least two of the virtual machines simultaneously.

8. The method of claim 1, wherein the physical device comprises at least one of:
an encoding device;
a networking device;
a compression engine;
a processing device; or
a data storage device.

9. The method of claim 8, wherein the physical device comprises a processing device configured as a graphics processing unit (GPU).

10. The method of claim 1, further comprising:
identifying data I/O hardware work queues of at least one additional physical device included as part of the host device;
selecting one or more of the identified data I/O hardware work queues of the at least one additional physical device to expose to the virtual machines;
generating additional virtual devices to furnish functionality of the at least one additional physical device to the virtual machines by relaying data between the virtual machines and the selected data I/O hardware work queues of the at least one additional physical device; and
exposing the additional virtual devices to the virtual machines.

11. A host device comprising:
a plurality of physical devices having data input/output (I/O) hardware work queues to receive data a respective physical device utilizes to furnish corresponding functionality;
a processor; and
computer-readable media having instructions stored thereon that are executable by the processor to implement a virtual machine device manager to perform operations for virtualizing the plurality of physical devices, the operations comprising:
identifying the data I/O hardware work queues of the plurality of physical devices; and
generating virtual devices representative of the plurality of physical devices, the generated virtual devices configured to furnish functionality of the plurality of physical devices to virtual machines by relaying the data utilized by the plurality of physical devices between the virtual machines and the identified data I/O hardware work queues of the plurality of physical devices.

12. The host device of claim 11, wherein the plurality of physical devices comprises one or more of:
an encoding device;
a networking device;
a compression engine;
a processing device; or
a data storage device.

13. The host device of claim 11, wherein the operations further comprise exposing the generated virtual devices to at least one of virtual machines hosted by the host device or different virtual machines hosted by at least one different host device.

14. The host device of claim 11, wherein the operations further comprise mapping input and output of the generated virtual devices to respective input and output of the identified data I/O hardware work queues and relaying the data utilized by the plurality of physical devices according to the mapping.

15. The host device of claim 11, wherein a number of the virtual devices generated for a particular physical device is based on a quantity of functionality the particular physical device is configured to furnish.

16. The host device of claim 15, wherein the generating includes generating at least two of the virtual devices to represent the particular physical device.

17. The host device of claim 16, wherein the operations further comprise furnishing the functionality of the particular physical device to at least two of the virtual machines simultaneously via the at least two virtual devices.

18. A method implemented by a host device, the method comprising:
receiving, from a virtual machine and at an input of a virtual device, a request requesting functionality furnished by a physical device corresponding to the virtual device;
determining a data input/output (I/O) hardware work queue of the physical device that is associated with the input of the virtual device based on a mapping of virtual-device inputs to data I/O hardware work queues of the physical device;
providing data included with the request to the physical device via the determined data I/O hardware work queue to enable the physical device to furnish the requested functionality with the provided data;
obtaining, by the virtual device, output data from the physical device that is indicative of a result of the functionality furnished by the physical device; and
outputting, by the virtual device, the output data to the virtual machine.

19. The method of claim 18, wherein the data included with the request excludes instructions for controlling operations of the physical device via control I/O of the physical device.

20. The method of claim 18, wherein at least some of the output data is displayable by a client device exposed to the virtual machine.
